(19) United States
(12) Patent Application Publication
(10) Pub. No.: US 2021/0182338 A1
(43) Pub. Date: Jun. 17, 2021

(54) RETRIEVAL SYSTEM AND VOICE RECOGNITION METHOD THEREOF

(71) Applicant: Sang Hyun SHIN, Seoul (KR)

(72) Inventor: Sang Hyun SHIN, Seoul (KR)

(21) Appl. No.: 17/125,233

(22) Filed: Dec. 17, 2020

(30) Foreign Application Priority Data
Dec. 17, 2019 (KR) 10-2019-0168848
May 11, 2020 (KR) 10-2020-0055735

(51) Int. Cl. G06F 16/9032; G06F 16/9035; G06F 16/9038; G06F 16/904

(52) U.S. Cl. CPC G06F 16/90324; G06F 16/904; G06F 16/9038; G06F 16/9035

(57) ABSTRACT

Provided is a method performed by a retrieval system. The method comprises receiving a search request from a user terminal, extracting a search keyword included in the received search request by the retrieval system, obtaining a search result corresponding to the search keyword by the retrieval system searching databases of a plurality of contact applications, and providing the search result to the user terminal, wherein each of the plurality of contact applications has an identifiable name, is associated with a different topic, and can operate independently from each other.

### CROSS-REFERENCE TO RELATED APPLICATIONS

A claim for priority under 35 U.S.C. § 119 is made to Korean Patent Application Nos. 10-2019-0168848 filed on Dec. 17, 2019 and 10-2020-0055735 filed on May 11, 2020 in the Korean Intellectual Property Office, the entire contents of which are hereby incorporated by reference.

### BACKGROUND

### Field

The present invention relates to a retrieval system and a voice recognition method thereof.

### Description of the Related Art

Since the introduction of Internet, many companies have built technology-based management systems and are striving to survive in a rapidly changing market environment. In this situation, the value of the platform is proportional to the weight it occupies in the business structure or system of the company.

The platform also performs its original role based on common elements of use, and it is the basis for developing and manufacturing complementary derivative products or services. In other words, the platform is not only a product itself, but also a part that composes a product, and it is a concept that encompasses intangible forms such as base services or software that help link with other services.

However, in the field of digital contents, a platform and its base system that can present a new concept according to the 4th industrial revolution, SNS, media, and commerce, and embrace various multi-applications in one system are not provided.

### SUMMARY

The technical problem to be solved by the present invention is to provide a retrieval system that provides an effective search means for data of various applications, and a voice recognition method thereof.

Another technical problem to be solved by the present invention is to provide a user-friendly user interface for performing various functions of a retrieval system.

The technical problems of the present invention are not limited to the technical problems mentioned above, and other technical problems that are not mentioned will be clearly understood by those skilled in the art from the following description.

According to an aspect of the inventive concept, there is provided a method performed by a retrieval system. The method comprises receiving a search request from a user terminal, extracting a search keyword included in the received search request by the retrieval system, obtaining a search result corresponding to the search keyword by the retrieval system searching databases of a plurality of contact applications, and providing the search result to the user terminal, wherein each of the plurality of contact applications has an identifiable name, is associated with a different topic, and can operate independently from each other.

According to an aspect of the inventive concept, there is provided a retrieval system. The system comprises one or more processors, a communication interface for communicating with a plurality of user terminals, a memory for loading a computer program performed by the processor, and a storage for storing the computer program, wherein the computer program includes instructions for performing operations comprising, receiving a search request from the user terminal, extracting a search keyword included in the received search request, searching databases of a plurality of contact applications to obtain a search result corresponding to the search keyword, and providing the search result to the user terminal, wherein each of the plurality of contact applications has an identifiable name, is associated with a different topic, and can operate independently from each other.

According to an aspect of the inventive concept, there is provided a method performed by a user terminal. The method comprises transmitting a search request to a retrieval system, receiving from the retrieval system a search result searched from databases of a plurality of contact applications by the retrieval system in response to the search request, and displaying the received search result on a screen, wherein each of the plurality of contact applications has an identifiable name, is associated with a different topic, and can operate independently from each other.

As described above, according to the present invention, it is possible to provide an effective search means for data of various applications.

Further, according to the present invention, it is possible to reduce a search scope and improve search performance by using each application classified by different topics.

Further, according to the present invention, a differentiated user experience (UX) can be provided to a user who uses the address book search function.

### BRIEF DESCRIPTION OF THE DRAWINGS

FIG. 1 is a schematic diagram illustrating a basic concept of a retrieval system according to an embodiment of the present invention.

FIG. 2 is a block diagram illustrating the configuration of a retrieval system according to an embodiment of the present invention.

FIG. 3 is a flowchart illustrating a method performed by a retrieval system according to an embodiment of the present invention.

FIG. 4 is an example illustrating a search structure for a plurality of contact applications according to an embodiment of the present invention.

FIG. 5 illustrates a main screen interface for searching a plurality of contact applications according to an embodiment of the present invention.

FIG. 6 illustrates search results for a plurality of contact applications according to an embodiment of the present invention.

FIG. 7 is an example illustrating a search interface using a search controller UI according to an embodiment of the present invention.

FIG. 8 is an example illustrating a search interface using a search controller UI according to an embodiment of the present invention.

FIG. 9 is an example illustrating a search request process based on voice utterance according to an embodiment of the present invention.

FIG. 10 is an example illustrating a search request process based on voice utterance according to an embodiment of the present invention.

FIG. 11 is a diagram illustrating an example, in which search results are aligned and provided in priority according to a predetermined criterion, according to an embodiment of the present invention.

FIG. 12 illustrates an example of providing a search result based on a user's search history according to an embodiment of the present invention.

FIG. 13 illustrates an example of providing a search result based on a user's location according to an embodiment of the present invention.

FIG. 14 illustrates an example of providing a search result based on basic information of a user according to an embodiment of the present invention.

FIG. 15 illustrates an example of providing a real-time search status of a retrieval system according to an embodiment of the present invention.

FIG. 16 illustrates an example of providing search information of interest when a user terminal accesses a retrieval system according to an embodiment of the present invention.

FIG. 17 is a flowchart illustrating a method performed by a user terminal according to an embodiment of the present invention.

FIG. 18 is a block diagram illustrating the configuration of a user terminal according to an embodiment of the present invention.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present invention, when it is determined that the detailed description of the related well-known configuration or function may obscure the gist of the present invention, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the invention. In this specification, the singular also includes the plural unless specifically stated otherwise in the phrase.

In addition, in describing the component of this invention, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, sore embodiments of the present invention will be described in detail with reference to the accompanying drawings.

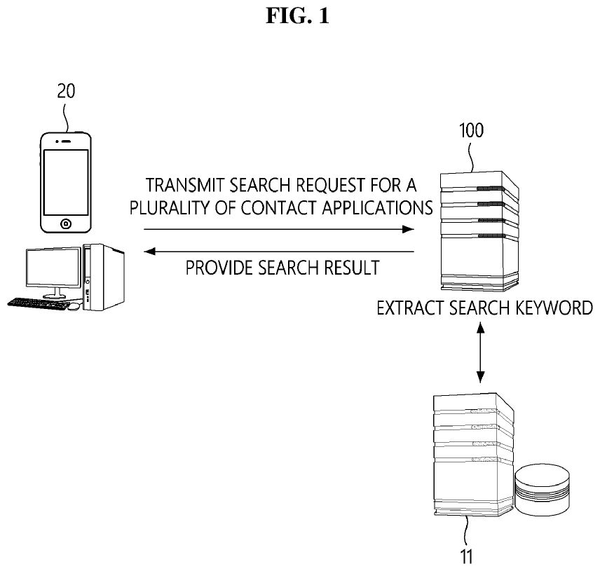

FIG. 1 is a schematic diagram illustrating a basic concept of a retrieval system according to an embodiment of the present invention.

In the illustrated example, the retrieval system 100 according to the present invention receives a search request for a plurality of contact applications from the user terminal 20. The plurality of contact applications may be implemented as, for example, a plurality of applications that are classified by different topics and provide an address book search function.

The retrieval system 100 extracts a search keyword included in the search request received from the user terminal 20. The retrieval system 100 obtains a search result including a word having a high similarity to the search keyword from the database 11, in which the address book-related data of each application is stored, and provides it to the user terminal 20.

The retrieval system 100 may be a fixed computing device, for example, a server device, but embodiments of the present invention are not limited thereto.

The user terminal 20 may be, for example, any one of a fixed computing device such as a personal desktop PC, or a mobile computing device such as a smart phone, a tablet PC, a laptop PC, a PDA, a virtual reality (VR) imaging device, an augmented reality (AR) imaging device.

In the illustrated configuration, the retrieval system 100 may be implemented as a WEB server that is connected to the user terminal 20 through a network and processes a response to an HTTP request from the web browser of the user terminal 20, and a WAS server that processes dynamic content or web application program services and is capable of interworking with the database 11. As an embodiment, the WAS server may include a function of a WEB server.

The database 11 may be implemented as a DB server that stores address book-related data provided by a plurality of contact applications and stores data processed by the retrieval system 100. Here, the address book-related data may include, for example, a user's profile or contact information, content information uploaded by a user, information for searching content, and the like.

As described above, the retrieval system 100 of the present invention may provide various search functions for data of a plurality of contact applications related to an address book to the user terminal 20.

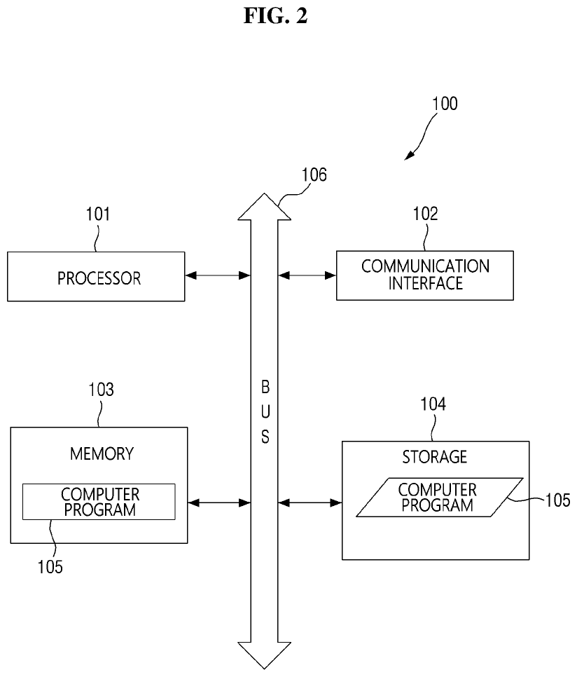

FIG. 2 is a block diagram illustrating the configuration of a retrieval system according to an embodiment of the present invention. The illustrated example shows the hardware configuration of the retrieval system 100.

Referring to FIG. 2, the retrieval system 100 is the computing device and may include one or more processors 101, a bus 106, a communication interface 102, a memory 103, which loads a computer program 105 executed by the processors 101, and a storage 104 for storing the computer program 105. However, FIG. 2 illustrates only the components related to the embodiment of the present disclosure. Therefore, it will be appreciated by those skilled in the art that the present disclosure may further include other general purpose components in addition to the components shown in FIG. 2.

The processor 101 controls overall operations of each component of the retrieval system 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure, the retrieval system 100 may have one or more processors.

The memory 103 stores various data, instructions and/or information. The memory 103 may load one or more programs 105 from the storage 104 to execute methods/operations according to various embodiments of the present disclosure. For example, when the computer program 105 is loaded into the memory 103, the logic (or the module tray be implemented on the memory 103. An example of the memory 103 may be a RAM, but is not limited thereto.

The bus 106 provides communication between components of the retrieval system 100. The bus 106 may be implemented as various types of bus such as an address bus, a data bus and a control bus.

The communication interface 102 supports wired and wireless internet communication of the retrieval system 100. The communication interface 102 may support various communication methods other than internet communication. To this end, the communication interface 102 may be configured to comprise a communication module well known in the art of the present disclosure.

The storage 104 can no temporarily store one or more computer programs 105. The storage 104 may be configured to comprise a non-volatile memory, such as a dead Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 105 may include one or more instructions, on which the methods/operations according to various embodiments of the present disclosure are implemented. When the computer program 105 is loaded on the memory 103, the processor 101 may perform the methods/operations in accordance with various embodiments of the present disclosure by executing the one or more instructions.

For example, the computer program 105 may comprise instructions for performing operations comprising receiving a search request from the user terminal, extracting a search keyword included in the received search request, searching databases of a plurality of contact applications to obtain a search result corresponding to the search keyword and providing the search result to the user terminal.

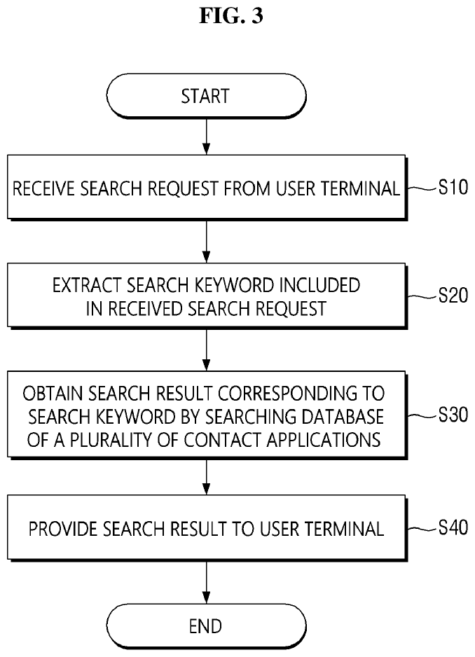

FIG. 3 is a flowchart illustrating a method performed by a retrieval system according to an embodiment of the present invention.

As shown in FIG. 3, first, in operation S10, the retrieval system 100 receives a search request from the user terminal 20.

As an embodiment, operation S10 may comprise an operation of receiving a first user command for selecting a first application from among a plurality of contact applications, and an operation of receiving a second user command for searching based on a database connected to the first application selected by the first user command from the user terminal.

Here, the first user command and the second user command may be voice commands uttered by a user of the user terminal 20 for search, or a user input through a keyboard or a mouse of the user terminal 20.

For example, in the case of the first user command for selecting the first application, it can be delivered by the user uttering the name of the first application among a plurality of contact applications that provide a search function of address books of different topics, or inputting through a keyboard at the user terminal 20.

Here, the first user command corresponds to a starting word that presents the criteria of the search scope of the database by uttering or inputting the name of the first application.

Once the first user command is received, a search may be performed based on a database connected to the first application by a second user command input or uttered thereafter. That is, the scope of the search is limited to the database connected to the first application through the first user command for selecting the first application, and accordingly, the search speed may be increased.

As an embodiment, operation S10 may further comprise an operation of receiving a search request for a first content type from among a plurality of content types selectable for the first application from the user terminal 20. As an embodiment, the operation of receiving a search request for the first content type may comprise an operation of receiving a third user command for selecting a first content type, and an operation of receiving a fourth user command for searching for data of a first content type selected by a third user command from the user terminal 20.

Here, the third user command and the fourth user command may be a voice command uttered by a user of the user terminal 20, or a user input through a keyboard or a mouse of the user terminal 20 for search.

For example, in the case of a third user command for selecting a first content type, it can be delivered by the user uttering the name of the first application among a plurality of contact applications selectable for the first application selected by the first user command or inputting through a keyboard at the user terminal 20.

Once the third user command is received, as for the fourth user command input or uttered thereafter, the search may be performed within a scope of data of the first content type stored in a database connected to the first application. That is, through the third user command for selecting the first content type, the scope of the search is limited to data of the first content type belonging to the database connected to the first application, and accordingly, the search speed may be increased.

As an embodiment, the search request may be generated based on a user input for selecting a UI item corresponding to the first application from among a plurality of UI items corresponding to each of a plurality of contact applications displayed on the screen of the user terminal 20.

Here, each of the plurality of contact applications has an identifiable name, is associated with a different topic, and can operate independently from each other.

As an embodiment, the plurality of contact applications may provide an interface means for social networking of first users associated with a first topic among different topics.

In this case, the interface means may comprise a first interface means for displaying a profile or contact information of first users, a second interface means for displaying a content uploaded by the first users, and a third interface means for searching the profile, contact information, or content.

As an embodiment, the plurality of UI items may include a name and logo of each of the plurality of contact applications, and may be displayed in the form of a button.

Next, in operation S20, the retrieval system 100 extracts a search keyword included in the received search request.

Next, in operation S30, the retrieval system 100 searches databases of a plurality of contact applications and obtains a search result corresponding to the search keyword. Operation S30, by a first user command corresponding to the starting word for uttering or inputting the name of the first application in operation S10, may provide a criterion of search scope for performing a search based on the database connected to the first application.

Here, the search result may include at least one of content, open chat, playlist, contact information, folder, product, map, and content grid.

As an embodiment, operation S30 includes an operation of identifying whether to select a UI item corresponding to the first application from the search request, and in this case, the search result may selectively include a search result related to the first application according to the identified result.

As an embodiment, in response to a search request for the first content type in operation S10, operation S30 may further include an operation of searching data of the first content type based on a database connected to the first application to obtain a search result corresponding to the search keyword.

As an embodiment, operation S30 further include an operation of receiving a search request for a first country from among a plurality of countries selectable for the first application from the user terminal 20, and an operation of searching data related to the first country based on a database connected to the first application to obtain a search result corresponding to the search keyword. At this time, the data related to the first country refers to data that is relevant with the first country such as data uploaded by a user whose nationality is the first country, data uploaded from the first country, or data including the name or flag of the first country in the title or content.

As an embodiment, the search request may be generated based on a user input for at least one search controller UI corresponding to a plurality of content types selectable for the first application.

Here, the search controller UI includes a first circular icon and a plurality of second circular icons, and a plurality of second circular icons may be circularly arranged at predetermined intervals in an area outside the boundary line of the first circular icon. The first circular icon and the plurality of second circular icons may respectively correspond to any one of a search type, function, content, and P-App.

Finally, in operation S40, the search system 100 provides the search result to the user terminal.

As an embodiment, the search results may be aligned and provided according to priority based on preset search criteria. In this case, the search criteria may be set with reference to the user's search frequency or the total search frequency of the retrieval system 100. In addition to this, the search criteria may be set in chronological order or in random order.

As an embodiment, the search result may be provided based on at least one of a user's search history, a user's location, and user's basic information.

As an embodiment, operation S40 may further include an operation of providing a real-time search status for a plurality of contact applications and a plurality of content types searched by all users of the retrieval system 100.

As an embodiment, operation S40 may further include an operation of providing search information corresponding to a contact application and content type of interest when the user terminal accesses by using the search request history of the user terminal 20.

In the following embodiment, an example, in which the retrieval system 100 provides a search result based on a voice command uttered by a user of the user terminal 20, will be described.

As an embodiment, in operation S10, the retrieval system 100 may receive a search request generated based on a voice command uttered by the user of the user terminal 20.

Here, the voice command may include a first voice command for selecting a first application from among a plurality of contact applications, and a second voice command for selecting a first content type from among a plurality of content types selectable for the first application selected by the first voice command.

As an embodiment, operation S20 may include an operation of sampling the audio signals of the first voice command and the second voice command and converting them into respective digital signals, an operation of extracting features from digital signals of each of the first voice command and the second voice command, and an operation of extracting words similar to each of the first voice command and the second voice command from a previously registered dictionary based on the extracted features of each of digital signals.

As an embodiment, operation S20 may further include an operation of recognizing a plurality of words included in a sentence when the voice command is composed of the sentence.

According to the method performed by the retrieval system 100 of the present invention as described above, it is possible to provide an effective search function for data of each of a plurality of contact applications that provide a search function of address books for different topics. Further, various types of search functions can be provided for entire data, in which all of a plurality of contact applications are integrated.

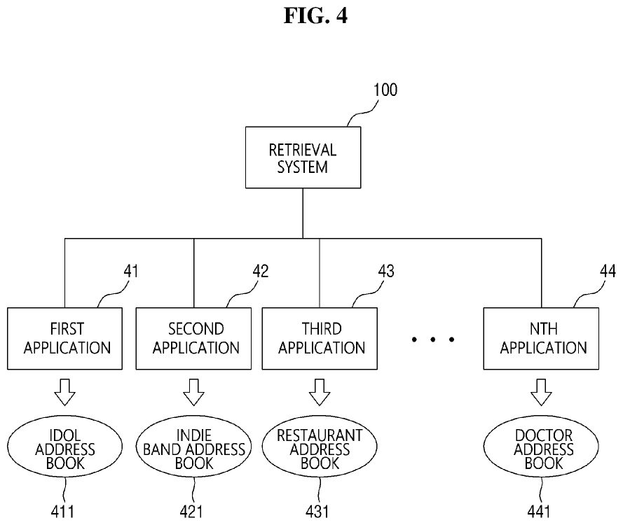

FIG. 4 is an example illustrating a search structure for a plurality of contact applications according to an embodiment of the present invention.

As shown, the retrieval system 100 of the present invention provides a search function for a plurality of contact applications.

The plurality of contact applications include a first application 41, a second application 42, a third application 43, . . . and the Nth application 44 which provide a search function of address books by different topics.

In the illustrated example, the first application 41 provides a function of searching an address book 411 related to the topic ‘Idol.’ The second application 42 provides a function of searching the address book 421 related to the topic ‘Indie Band,’ and the third application 43 provides a function of searching the address book 431 related to the topic ‘Restaurant.’ Further, the Nth application 44 provides a function of searching the address book 441 related to the topic ‘Doctor.’

As described above, the retrieval system 100 of the present invention may provide, in providing an address book search function, faster and more efficient search results than in the case of searching data of all of the plurality of contact applications by providing a user interface capable of searching for each of a plurality of contact applications related to different topics.

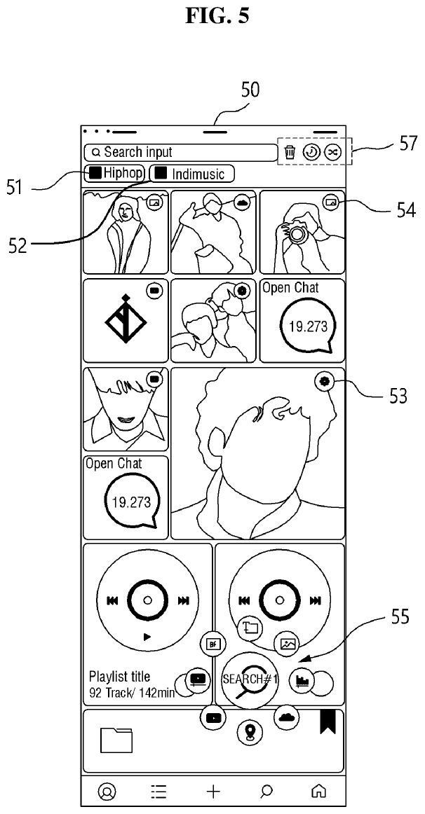

FIG. 5 illustrates a main screen interface for searching a plurality of contact applications according to an embodiment of the present invention.

In the illustrated example, the retrieval system 100 provides the search function for various contents (photo, GIF, sound cloud, YouTube, video, or music), open chat, playlists, contact information, folders, product information, maps, and content grids related to an address book provided by a plurality of contact applications 41, 42, 43, . . . , 44 through the main screen interface 50 of the user terminal 20.

In this case, the address book provided by the plurality of contact applications 41, 42, 43, . . . , 44 may be a direct contact type address book. The direct contact refers to a system of address books where people gather on a specific topic. For example, the direct contact may be various address books such as an idol address book 411, an indie band address book 421, a restaurant address book 431, a doctor address book 441, or a lawyer address book (not shown), as shown in the example of FIG. 4. The address book of this direct contact type can be considered as being categorized once based on its topic.

As an embodiment, a search function for a plurality of contact applications 41, 42, 43, . . . , 44 provided to the user terminal 20 by the retrieval system 100 may be performed by a voice command uttered by the user, or a user input through a keyboard or mouse.

For example, in order to search for a first application that provides an address book function related to ‘Hiphop,’ the user may give a command by directly uttering the name of the first application as ‘Hiphop’ or inputting ‘Hiphop’ in the search box. In response to such a user's command, the retrieval system 100 may limit the scope of the search to the database connected to the first application, and perform a search based on the database connected to the first application for keywords uttered or input thereafter. Accordingly, it is possible to provide a faster search than the case of searching the entire database of a plurality of contact applications.

As an embodiment, the UI item 51, 52 corresponding to each of the plurality of contact applications 41, 42, 43, . . . , 44 providing a direct contact type address book may be displayed on the main screen interface 50 of the user terminal 20.

As an embodiment, when the first UI item 51 of the first application related to ‘Hiphop’ is selected, data of an address book related to Hiphop can be searched, and when the second UI item 52 of a second application related to ‘Indimusic’ is selected, data of an address book related to Indie music can be searched.

Further, the plurality of contact applications 41, 42, 43, . . . , 44 may include a plurality of content types that perform various functions within the user terminal 20. The plurality of content types may respectively correspond to any one of, for example, a search type, function, content, and P-App. At this time, P-App is a mini application, and can be considered as being respectively categorized by its name.

As an embodiment, the retrieval system 100 may provide a search function for a plurality of content types selectable for each of the plurality of contact applications 41, 42, 43, . . . , 44. A search function for a plurality of content types may also be performed by a voice command uttered by a user or a user input through a keyboard or mouse.

As an example, in order to search for a ‘playlist’ P-App within the first application related to ‘Hiphop,’ the user may give a command by first uttering the name of the first application as ‘Hiphop’ or inputting it in the search box, and then directly uttering the name of P-App as ‘playlist’ or inputting it in the search box. According to such a user's command, the retrieval system 100 may limit the scope of the search to the data of the ‘playlist’ P-App based on the database connected to the first application, and perform a search within the data of ‘playlist’ P-App for keywords uttered or inputted thereafter.

As another example, in order to search for a specific sound source of ‘DNA’ in ‘A player’ P-App, the user may give a command by directly uttering a sentence including the name of P-App and the search keyword, such as ‘A player, play DNA’, or inputting it in the search box. In accordance with such a user's command, the retrieval system 100 limits the scope of the search to a music database of ‘A player,’ and automatically recognizes ‘DNA’ as music so that the ‘DNA’ sound source can be played immediately.

In the same manner as described above, the retrieval system 100 does not search the entire database, but only searches data of a specific content type within a contact application related to a specific topic, thereby providing faster and more efficient search performance.

As an embodiment, a search controller UI 55 corresponding to a plurality of content types selectable for each of a plurality of contact applications 41, 42, 43, . . . , 44 may be displayed on the main screen interface 50 of the user terminal 20.

As an embodiment, after selecting the first UI item 51 of the first application related to ‘Hiphop,’ when the desired content type is selected through the search controller UI 55, search results including various types of content, such as the playlist P-App, photo, video and open chat, can be checked on the screen.

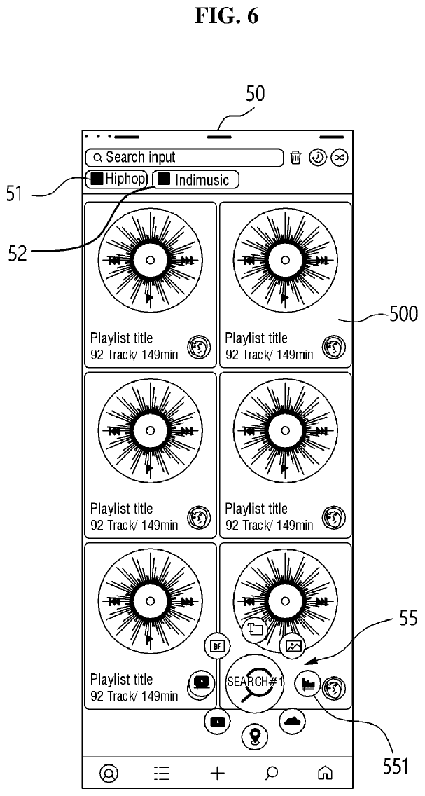

For example, as shown in FIG. 6, after selecting the first UI item 51 of the first application related to ‘Hiphop,’ when the ‘playlist’ icon 551 is selected among icons of the search controller UI 55, the search result 500 including the playlist content related to Hiphop can be checked on the screen.

As an embodiment, without requesting a search by specifying a specific application and a specific content type in the user terminal 20 of the present invention, after receiving the entire search result for the search word from the retrieval system 100, the result can be filtered for a specific application and a specific content type.

The search method related to the above embodiment may be performed in the following steps.

1. A search word to be searched is input in a search tab of an application related to a specific topic among a plurality of contact applications 41, 42, 43, . . . , 44.

2. On the basis of the database 11 storing data of all address books, various results corresponding to the search word appear. For example, various contents (photo, GIF, sound cloud, YouTube, video, music, etc.), open chat, playlists, contact information, folders, products, maps, content grids, and the like may be provided according to the search result.

3. At the bottom of the search box, a first UI item 51 and a second UI item 52, in which the names and logos of the first application and the second application are displayed in the form of a button, are provided.

4. If the UI item 51 or 52 of the application related to a specific topic is clicked, the search result is filtered to output only data in the corresponding address book. This filtering function is not limited to selecting an address book, but can also be applied to filtering by country or various other criteria.

5. A search controller UI 55 for searching may be provided together on the search screen. The search controller UI 55 is to provide a user-friendly search function and a user interface, and a specific form thereof will be described later in FIG. 6.

6. A user can perform various search functions by using an icon of the search controller UI 55 provided. For example, when a user selects a specific icon (e.g., a video button) of the search controller UI 55, the search result is filtered based on this and only video content is displayed on the search screen.

As described above, in providing a search function of an address book, the retrieval system 100 of the present invention may provide a user interface having a hierarchical structure so that an application of a specific topic and a specific content type can be selected. Accordingly, since the scope of data search is narrowed when searching an address book, a search result with high accuracy and speed can be provided.

As an embodiment, a plurality of function buttons 57 for convenient user search may be displayed on the main screen interface 50 of the user terminal 20. In the illustrated example, when the user selects each function button 57, the designated function of each button is performed. For example, when the first button among the function buttons 57 is selected, a function of erasing a currently input search word and returning to an initial search box may be performed. When the second button among the function buttons 57 is selected, a function of arranging the search results in the order of time (for example, uploaded time) is performed, and when the third button among the function buttons 57 is selected, a function of randomly rearranging (e.g., shuffling) the search results may be performed.

As an embodiment, icons 53 and 54 indicating the content type of the search result may be displayed together in the search result displayed on the search screen. For example, a ‘playlist icon’ 53 may be displayed when the search result is a playlist, and a ‘photo icon’ 54 may be displayed when the search result is a photo content.

FIG. 6 illustrates search results for a plurality of contact applications according to an embodiment of the present invention. FIG. 6 illustrates a screen displayed according to selection of an icon of the UI item 51 or 52 and the search controller UI 55 of the application as shown in FIG. 5.

In the illustrated example, when the first UI item 51 of the first application related to ‘Hiphop’ is selected, the search controller UI 55 previously set for the first UI item 51 of the first application may be displayed.

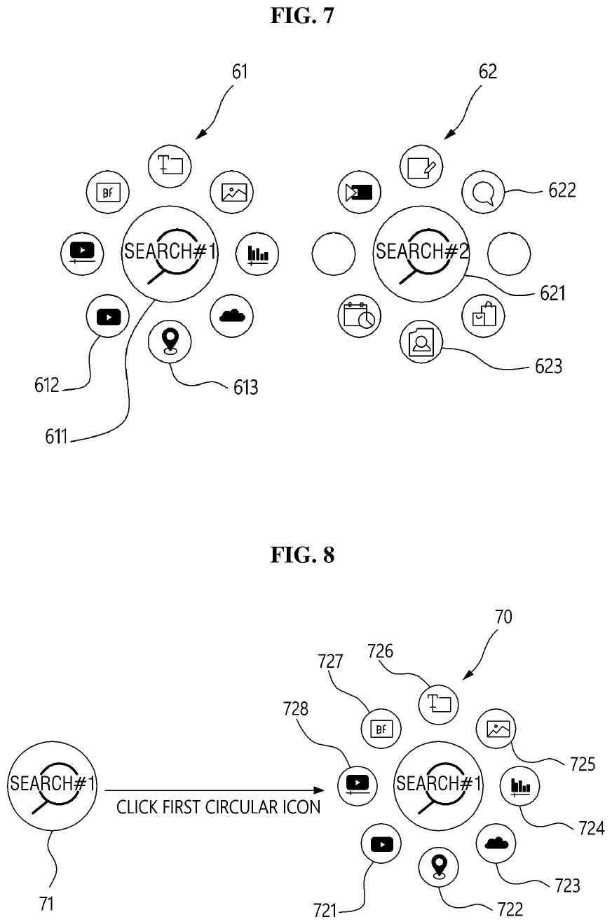

The search controller UI 55 displays functions, contents, and P-Apps related to ‘Hiphop’ in the form of icons, and when selecting, for example, the ‘Playlist’ icon 551, a search result 500 including the playlist contents related to Hiphop may be displayed on the screen. FIG. 7 is an example illustrating a search interface using a search controller UI according to an embodiment of the present invention.

In the illustrated example, the search controller UIs 61 and 62 are configured in the form, in which a plurality of second circular icons 612, 613, 622 and 623 are circularly arranged at a predetermined interval in an area outside the boundary line of the first circular icons 611 and 621 displayed in the center.

The first circular icons 611 and 621 and the plurality of second circular icons 612, 613, 622, and 623 may be mapped to any one of a search type, function, content, and P-App, respectively.

For example, the first search controller UI 61 may display a first circular icon 611 in the center, and a second circular icon 612 corresponding to a content type of ‘Youtube’ and a second circular icon 613 corresponding to a content type of ‘location’ around the first circular icon 611.

As another example, the second search controller UI 62 may display a first circular icon 621 in the center, and a second circular icon 622 corresponding to the content type of ‘open chat’ and a second circular icon 623 corresponding to the content type of ‘contact information’ around the first circular icon 621.

As an embodiment, an icon selected by the user among the first circular icons 611 and 621 and the plurality of second circular icons 612, 613, 622, 623 may be highlighted or changed in color to distinguish it from other icons.

As an embodiment, the search controller UIs 61 and 62 may be freely arranged at any position on the screen by a user's manipulation.

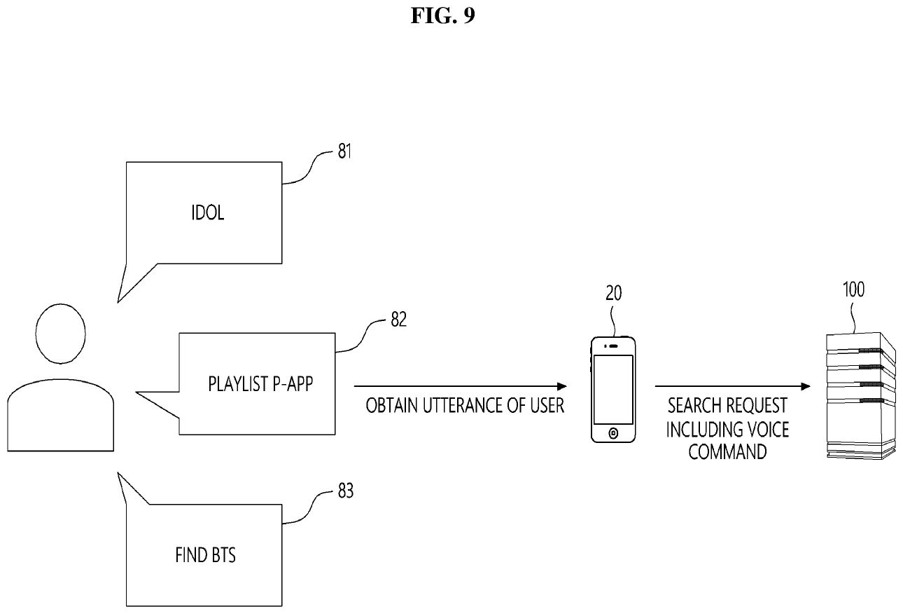

FIG. 8 is an example illustrating a search interface using a search controller UI according to an embodiment of the present invention.

As an embodiment, as shown, the search controller UI 70 displays the first circular icon 71, and when the first circular icon 71 is selected, a plurality of second circular icons 721, 722, 723, 724, 725, 726, 727, 728 may be displayed to be circularly arranged around the first circular icon 71 at predetermined intervals.

FIG. 9 is an example illustrating a process of requesting a search by voice utterance according to an embodiment of the present invention.

As an embodiment, the retrieval system 100 may perform a search of the database 11 using voice recognition. In this case, since the user can perform a search without directly typing a search word, the search speed is drastically increased, the search time is shortened, and the user's convenience is also increased.

Conventional general speech recognition searches had to first say the starting words for speech recognition, such as ‘Hey Siri,’ ‘Alexa,’ and ‘GIGA Genie,’ and then say the search word to be found. And, when the search word was called, information to be found should be searched in a wide range of data areas. That is, there is a problem in that the step of calling a starting word irrelevant to the direct search function is necessarily added, thereby reducing user convenience, and there is a problem in that the search speed is significantly reduced by targeting entire data having a wide search scope.

In the search method according to the retrieval system 100 of the present invention, by using a starting word that calls the name of an address book application, the starting word itself presents the criteria of the database search scope, and then, by designating a specific search target in stages, searching speed and efficiency are maximized.

In the illustrated example, when the retrieval system 100 receives a search request from the user terminal 20, a search request based on a voice command uttered by the user is received.

As an embodiment, the user terminal 20 obtains a voice command uttered by the user, and in this case, the voice command may include a first voice command for selecting a specific application among a plurality of contact applications and a second voice command for selecting a specific content type from among a plurality of content types selectable for a specific application selected by the first voice command.

For example, when the user utters ‘IDOL’ as the first voice command 81, the retrieval system 100 narrows the search scope to an application related to ‘IDOL’ once. At this time, when the user utters ‘Playlist P-App’ as the second voice command 82, the retrieval system 100 can narrow the scope of the search once more to a search for contents corresponding to the content type of ‘Playlist P-App.’ Then, the user finally searches for specific information to be found for by uttering a specific search target such as ‘Find BTS’ as the third voice command 83.

As an embodiment, the retrieval system 100 may receive an audio signal of a voice command uttered by a user and perform a voice recognition process using a voice recognition engine.

As an example, the retrieval system 100 may perform sampling the audio signals of each of the first voice command 81, the second voice command 82 and the third voice command 83, convert them into digital signals, and extract features from each of the digital signals.

Further, speech recognition may be performed by extracting words most similar to each of the first voice command 81, the second voice command 82, and the third voice command 83 from a dictionary previously registered in the database 11 based on the extracted features of each of digital signals.

As another embodiment, the retrieval system 100 does not directly perform speech recognition for the voice command uttered by the user, but may receive the recognition result of the voice command performed by the voice recognition engine implemented in the user terminal 20 to perform a search function.

As an embodiment, when the retrieval system 100 provides the entire search result for the search word uttered by the user to the user terminal 20, the user terminal 20 may utter the name of a specific application to filter the results for a specific application among the entire search results.

Further, if the name of a specific application is uttered in the user terminal 20 and then the name of a specific content type is uttered, the result of the specific content type among the results filtered for the specific application may be filtered again.

As described above, the retrieval system 100 of the present invention performs a search step by step by uttering the categorized directories, for example, the name of an application or the name of a P-App related to a specific topic for address book search, unlike existing retrieval systems. In this way, the scope of the search target can be greatly narrowed, thereby improving search efficiency and search speed overwhelmingly. Furthermore, the search results can also be much more accurate because the search results are derived within the categorized directory.

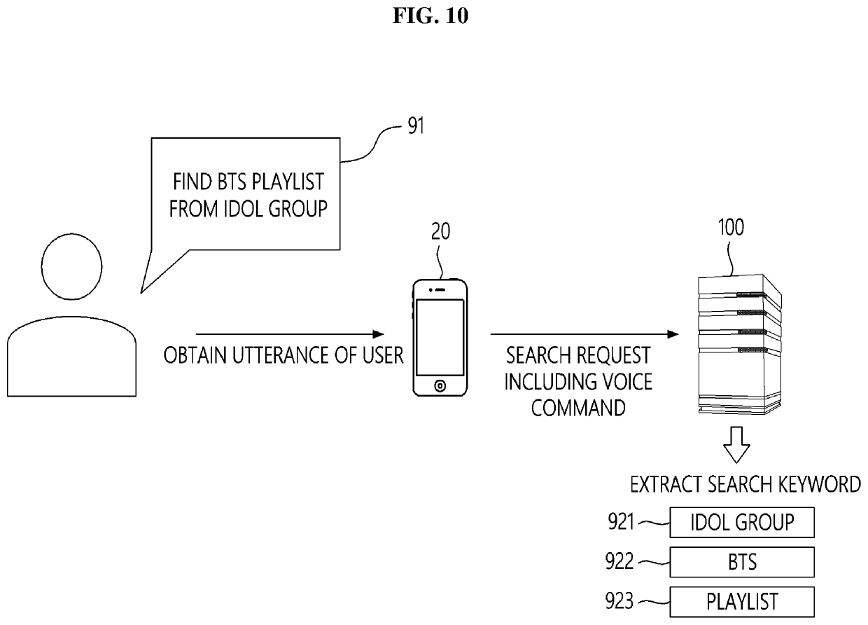

FIG. 10 is an example illustrating a process of requesting a search based on voice utterance according to an embodiment of the present invention.

As an embodiment, as illustrated, when a voice command uttered by a user consists of a sentence, the retrieval system 100 may perform a speech recognition process by recognizing a plurality of words included in the sentence.

As an example, when the user utters ‘Find BTS playlist from idol groups’ as a voice command 91, the retrieval system 100 extracts ‘idol groups’ corresponding to the first keyword 921, ‘BTS’ corresponding to the second keyword 922 and ‘playlist’ corresponding to the third keyword 923 in the sentence, respectively.

At this time, the retrieval system 100 analyzes the extracted keywords 921, 922, and 923 to determine which search step each keyword corresponds to. For example, the retrieval system 100 may determine that ‘idol groups’ refers to the name of an application for address book search, ‘BTS’ refers to a detailed search target, and ‘playlist’ refers to the name of P-App. Then, the retrieval system 100 derives the result after performing a step-by-step search using keywords extracted according to each search step.

According to the above method, a step-by-step search using the speech recognition function can be performed by simply saying one search sentence at the beginning, without the user having to say the search word every search step. Accordingly, user convenience and search speed may be further improved.

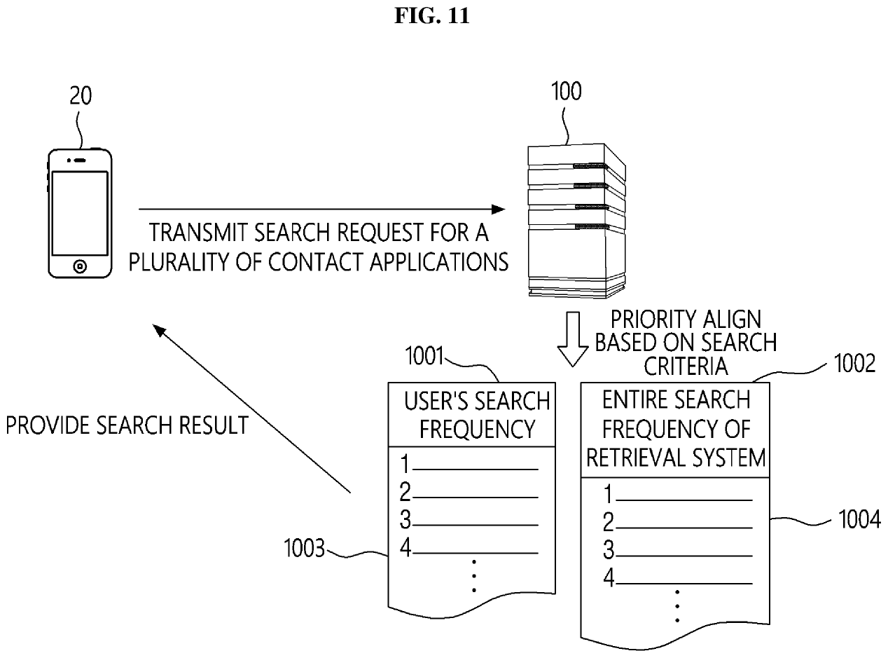

FIG. 11 is a diagram illustrating an example, in which search results are aligned in priority according to a predetermined criterion and provided, according to an embodiment of the present invention.

In the illustrated example, in providing search results for a plurality of contact applications 41, 42, 43, . . . , 44, the retrieval system 100 may align and provide them according to a priority based on a predetermined search criterion.

In this case, the search criterion may be set to refer to a search frequency of a user or to a search frequency of the entire retrieval system.

As an example, in the case of determining the priority based on the user's search frequency 1001, the retrieval system 100 may display the search result 1003 in the upper part as the number of times the user previously searched for it is higher, and may display the search result 1003 in the lower part as the number of times the user previously searched for it is lower.

As another example, in the case of determining the priority based on the search frequency 1002 of the entire search system, the retrieval system 100 may display the search result 1004 in the upper part as the number of times all users searched for it is higher, and may display the search result 1004 in the lower part as the number of times all users searched for it is lower.

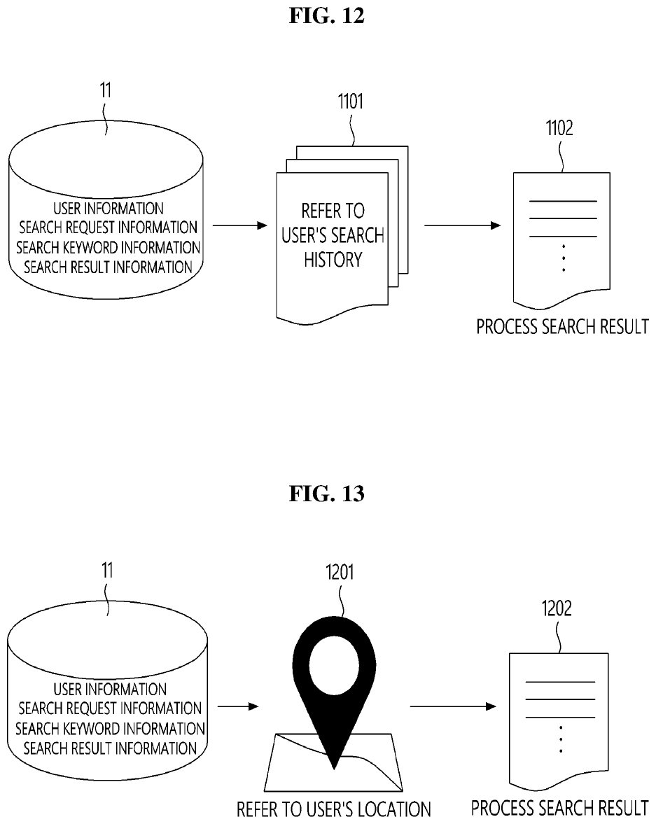

FIG. 12 illustrates an example of providing a search result based on a user's search history according to an embodiment of the present invention.

In the illustrated example, in providing search results for a plurality of contact applications 41, 42, 43, . . . , 44, the retrieval system 100 may provide the search result 1102 processed in the order of high relevance using the user's search history 1101 among the information stored in the database 11.

As an example, in the case of using the correlation with the previous search word, the retrieval system 100 may display the search result that has a higher correlation with the search word searched by the user immediately before in the upper part, and display the search result that has a lower correlation in the lower part. For example, if a user searched for a Christmas carol immediately before and this time has searched for BTS, the retrieval system may display those related to the Christmas carol among the search results of the BTS in the more upper part.

FIG. 13 illustrates an example of providing a search result based on a user's location according to an embodiment of the present invention.

In the illustrated example, in providing search results for a plurality of contact applications 41, 42, 43, . . . , 44, the retrieval system 100 may provide search result 1202 processed in the order of high relevance using the user's location information 1201.

In this case, the user's location information 1201 may be obtained by referring to user information stored in the database 11 or through a location tracking function.

For example, in the case of using the user's location information, the retrieval system 100 may display the search result related to an area close to the user's location among the search results in the upper part, and display the search result related to an area far from the user's location in the lower part.

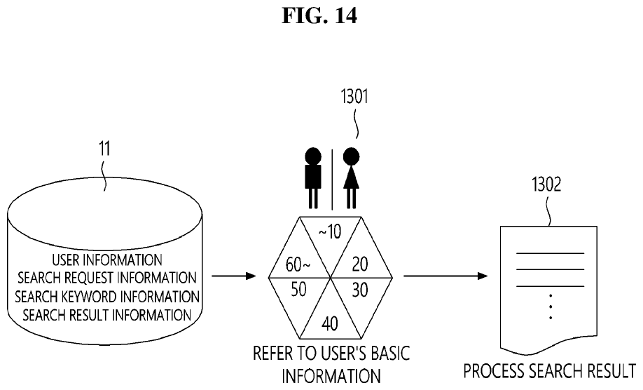

FIG. 14 illustrates an example of providing a search result based on basic information of a user according to an embodiment of the present invention.

In the illustrated example, in providing search results for a plurality of contact applications 41, 42, 43, . . . , 44, the retrieval system 100 may provide the search result 1302 processed in the order of high relevance using basic information of the user 1301 among the information stored in the database 11. In this case, the user's basic information 1301 may include, for example, information on the user's location, age, gender, or residential area.

For example, in the case of using the user's age and gender information, the retrieval system 100 may display search results related to users of the same gender in the same age group as the user among the search results.

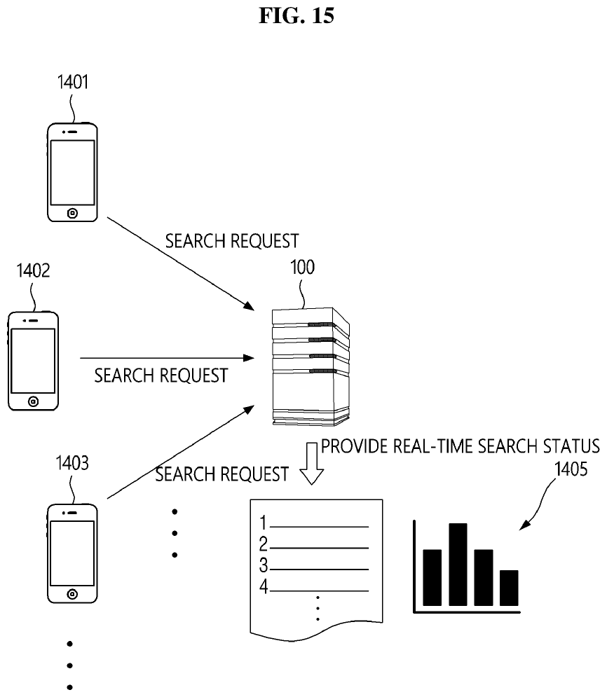

FIG. 15 illustrates an example of providing a real-time search status of the retrieval system according to an embodiment of the present invention.

In the illustrated example, the retrieval system 100 of the present invention may provide a real-time search status 1405 regarding a plurality of contact applications 41, 42, 43, . . . , 44, a content type, and a search word.

As an example, the retrieval system 100 may analyze a search request received from a plurality of connected user terminals 1401, 1402, 1403, . . . in real time, and may extract information on applications with high views of users from among the plurality of contact applications 41, 42, 43, . . . , 44, and information on content types with high views of users from among a plurality of content types including a search type, function, content, and P-App. Further, information on the ranking of search words with high views of users and search words with increasing ranking may be extracted and provided.

As described above, the retrieval system 100 of the present invention provides a user with real-time search status regarding an application, a content type, and a search word, so that search information of interest to the public can be grasped in real time.

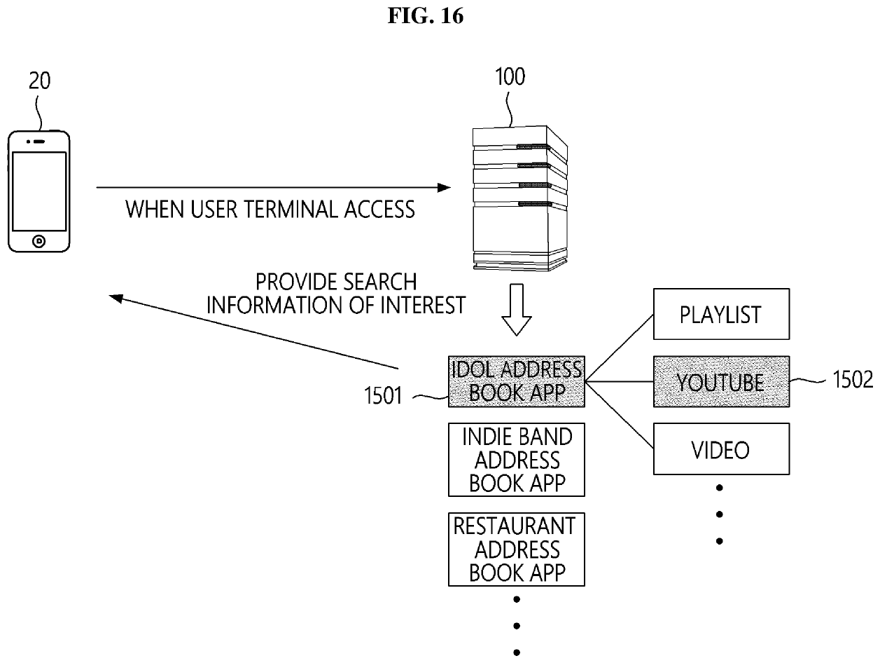

FIG. 16 illustrates an example of providing search information of interest when a user terminal accesses a retrieval system according to an embodiment of the present invention.

In the illustrated example, the retrieval system 100 of the present invention may provide search information corresponding to a contact application and content type of interest to the user when the user terminal 20 accesses.

As an example, the retrieval system 100 may analyze the user's search request history information stored in the database 11, and extract the ‘idol address book app’ which is the user's interest application 1501 and the ‘Youtube’ which is the user's interest content type 1502.

From this, the retrieval system 100 may automatically provide search information corresponding to the application of interest 1501 and the content type of interest 1502 when the user accesses.

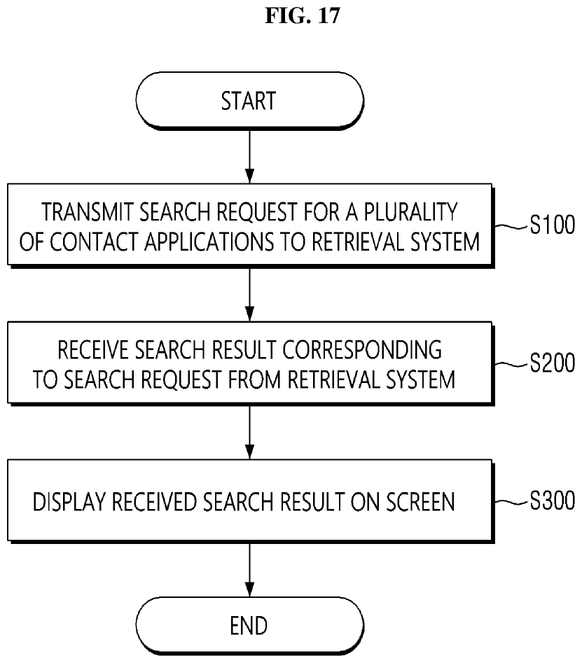

FIG. 17 is a flowchart showing a method performed by a user terminal according to an embodiment of the present invention.

As shown, first, in operation S100, the user terminal 20 transmits a search request for a plurality of contact applications to the retrieval system 100.

Here, the plurality of contact applications are associated with different topics and can operate independently from each other.

As an embodiment, a first application among a plurality of contact applications may provide an interface means for social networking of first users associated with the first topic among different topics.

Here, the interface means may include a first interface means for displaying a profile or contact information of the first users, a second interface means for displaying a content uploaded by the first users, and a third interface means for searching a profile, contact information, or a content.

For example, a plurality of contact applications are implemented as address book apps that provides a search function for people's profiles, contact information, uploaded contents, etc. related to different topics such as ‘idol,’ ‘indie band,’ ‘restaurant,’ and ‘doctor.’

As an embodiment, operation S100 may further include an operation of displaying a plurality of UI items corresponding to each of the plurality of contact applications on the screen. In this case, the search request may be generated based on a user input for selecting a UI item corresponding to the first application from among the plurality of UI items.

As an embodiment, operation S100 may further include an operation of displaying at least one search controller UI corresponding to a plurality of content types selectable for the first application on the screen. In this case, the search request may be generated based on a user input for selecting a first content type from among a plurality of content types through the search controller UI.

In this case, the search controller UI may include a first circular icon and a plurality of second circular icons, and a plurality of second circular icons may be circularly arranged at predetermined intervals in an area outside the boundary line of the first circular icon. The first circular icon and the plurality of second circular icons may respectively correspond to any one of a search type, function, content, and P-App.

Next, in operation S200, the user terminal 20 receives a search result corresponding to the search request from the retrieval system 100.

As an embodiment, the search result may include at least one of content, open chat, playlist, contact information, folder, product, map, and content grid.

Finally, in operation S300, the user terminal 20 displays the search result received from the retrieval system 100 on the screen.

As an embodiment, operation S300 may include an operation of filtering the received search result based on a user input for selecting a UI item corresponding to a first application from among the plurality of UI items.

Further, operation S300 may further include an operation of filtering the received search result based on a user input for selecting a first content type from among a plurality of content types selectable for the first application through the search controller UI.

Accordingly, in providing an address book search function, a user interface capable of filtering for a specific content type may be provided after receiving entire search results based on a search word and filtering for a specific application.

As an embodiment, an operation of receiving a voice command uttered by a user and an operation of filtering the received search result based on the received voice command may be included. Accordingly, in providing an address book search function, after entire search results based on a search word are received, results for a specific application may be filtered through a voice command.

Here, the voice command may include a first voice command for selecting a first application from among the plurality of contact applications and a second voice command for selecting a first content type from among a plurality of content types selectable for the first application selected by the first voice command.

As described above, according to the method performed by the user terminal 20 of the present invention, in order to search the address book of a specific topic, the user does not need to search all data of the entire address book, and may obtain a desired search result faster and more easily by using a plurality of contact applications that provide a search function of the address book for each topic.

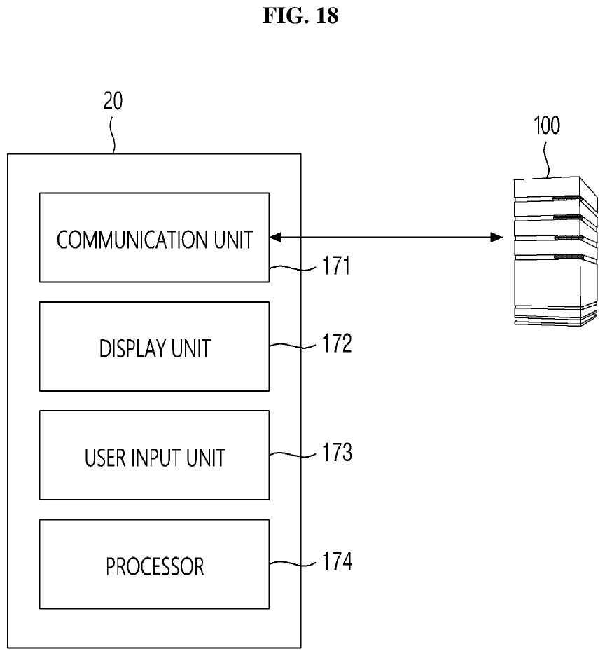

FIG. 18 is a block diagram showing the configuration of a user terminal according to an embodiment of the present invention.

As shown, the user terminal 20 of the present invention is connected to the retrieval system 100 through a network.

The user terminal 20 includes a communication unit 171, a display unit 172, a user input unit 173, and a processor 174. The user terminal 20 is implemented as, for example, a smart phone, a tablet, or a PC. The configuration included in the user terminal 20 of the present invention is not limited by the above-described exemplary embodiment and may be implemented including additional other configurations.

The communication unit 171 communicates with the retrieval system 100 using a wired or wireless communication method. The communication unit 171 may communicate with the retrieval system 100 in a wired communication method such as Ethernet, or communicate with the retrieval system 100 through a wireless router in a wireless communication method such as Wi-Fi or Bluetooth.

For example, the communication unit 171 may be provided as a printed circuit board (PCB) including a wireless communication module such as Wi-Fi. The communication method of the communication unit 171 is not limited thereto, and may be communicated with the retrieval system 100 using another communication method.

The display unit 172 displays information. For example, the display unit 172 may display an image based on an image signal. The display unit 172 may be implemented in various forms, such as a plasma display panel (PDP), a liquid crystal display (LCD), organic light emitting diodes (OLED), and a flexible display.

The user input unit 173 receives a user input. For example, the user input unit 173 may receive a user input for selecting a part of a user interface displayed on the display unit 172.

The user input unit 173 may be implemented as a keyboard, a mouse, etc. connected to the user terminal 20, or may be implemented as a touch screen provided in the user terminal 20.

The processor 174 transmits a search request for a plurality of contact applications to the retrieval system 100. A plurality of contact applications are associated with different topics and can operate independently from each other. The processor 174 may be implemented as, for example, a CPU (Central Processing Unit).

As an embodiment, the processor 174 may control the display unit 172 to display a plurality of UI items corresponding to each of the plurality of contact applications. In this case, the search request may be generated based on a user input for selecting a UI item corresponding to the first application from among the plurality of UI items.

Further, the processor 174 may control the display unit 172 to display at least one search controller UI corresponding to a plurality of content types selectable for the first application. In this case, the search request may be generated based on a user input for selecting a first content type from among the plurality of content types through the search controller UI.

As an embodiment, the processor 174 may transmit a search request based on a voice command uttered by a user to the retrieval system 100. In this case, the search request may include the audio signal of the voice command itself, or may include a voice recognition result for the voice command recognized through the voice recognition engine implemented in the user terminal 20.

At this time, the voice command may include a first voice command for selecting a first application among a plurality of contact applications and a second voice command for selecting a first content type from among a plurality of content types selectable for the first application selected by the first voice command.

The processor 174 receives a search result corresponding to the search request from the retrieval system, and controls the display unit 172 to display the received search result.

As an embodiment, the processor 174 may filter the received search result based on a user input for selecting a UI item corresponding to the first application from among a plurality of UI items. Further, the processor 174 may filter the received search result based on a user input for selecting a first content type from among the plurality of content types through the search controller UI.

Accordingly, the user terminal 20 according to the present invention may provide a user interface capable of filtering a specific content type after receiving entire search results based on a search word and filtering for a specific application.

As an embodiment, the processor 174 may receive a voice command uttered by a user, and filter the received search result based on the received voice command.

Accordingly, the user terminal 20 may filter results for a specific application through a voice command after receiving entire search results based on the search word.

As described above, according to the user terminal 20 of an embodiment of the present invention, it is possible to provide a user interface having a hierarchical structure so that an application of a specific topic and a specific content type can be selected. Accordingly, when searching an address book, since the scope of data search is narrowed, search results with high accuracy and speed can be provided.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A method performed by a retrieval system comprising,
receiving a search request from a user terminal;
extracting a search keyword included in the received search request by the retrieval system;
obtaining a search result corresponding to the search keyword by the retrieval system searching databases of a plurality of contact applications; and
providing the search result to the user terminal,
wherein each of the plurality of contact applications has an identifiable name, is associated with a different topic, and can operate independently from each other.

2. The method of claim 1,
wherein receiving a search request from the user terminal comprises,
receiving a first user command for selecting a first application from among the plurality of contact applications; and
receiving a second user command for searching based on a database connected to the first application selected by the first user command from the user terminal.

3. The method of claim 2,
wherein the first user command includes a voice command for uttering a name of the first application or a user input for inputting a name of the first application, and
wherein the second user command includes a voice command for uttering a search word to request a search based on a database connected to the first application or a user input for inputting the search word.

4. The method of claim 2 further comprising,
receiving a search request for a first content type from among a plurality of content types selectable for the first application from the user terminal; and
obtaining a search result corresponding to the search keyword by searching for data of the first content type based on a database connected to the first application,
wherein each of the plurality of content types has an identifiable name.

5. The method of claim 4,
wherein receiving a search request for the first content type comprises,
receiving a third user command for selecting the first content type; and
receiving a fourth user command for searching data of the first content type selected by the third user command from the user terminal.

6. The method of claim 5,
wherein the third user command includes a voice command for uttering a name of the first content type or a user input for inputting a name of the first content type, and
wherein the fourth user command includes a voice command for uttering a search word to request a search within a scope of data of the first content type stored in a database connected to the first application or a user input for inputting the search word.

7. The method of claim 1,
wherein a first application among the plurality of contact applications provides an interface means for social networking of first users associated with a first topic among the different topics.

8. The method of claim 7,
wherein the interface means comprises,
a first interface means for displaying a profile or contact information of the first users;
a second interface means for displaying a content uploaded by the first users; and
a third interface means for searching the profile, contact information or content.

9. The method of claim 1,
wherein the search request is generated based on a user input for selecting a UI item corresponding to the first application from among a plurality of UI items corresponding to each of the plurality of contact applications displayed on a screen of the user terminal.

10. The method of claim 9,
wherein the plurality of UI items include a name and logo of each of the plurality of contact applications, and are displayed in the form of a button.

11. The method of claim 9 further comprises,
identifying whether to select a UI item corresponding to the first application from the search request,
wherein the search result selectively includes a search result related to the first application according to the identified result.

12. The method of claim 1 further comprises,
receiving a search request for a first country from among a plurality of countries selectable for a first application from among the plurality of contact applications from the user terminal; and
obtaining a search result corresponding to the search keyword by searching data related to the first country based on a database connected to the first application.

13. The method of claim 1,
wherein the search request is generated based on a user input for at least one search controller UI corresponding to a plurality of content types selectable for a first application from among the plurality of contact applications.

14. The method of claim 13,
wherein the search controller UI includes a first circular icon and a plurality of second circular icons, and
wherein the plurality of second circular icons are circularly arranged at predetermined intervals in an area outside a boundary line of the first circular icon.

15. The method of claim 14,
wherein the first circular icon and the plurality of second circular icons respectively correspond to any one of a search type, function, content, and P-App.

16. The method of claim 1,
wherein the search result includes at least one of content, open chat, playlist, contact information, folder, product, map, and content grid.

17. The method of claim 1,
wherein the search request is generated based on a voice command uttered by a user of the user terminal.

18. The method of claim 17,
wherein the voice command includes a first voice command for selecting a first application from among the plurality of contact applications, and a second voice command for selecting a first content type from among a plurality of content types selectable for the first application selected by the first voice command.

19. A retrieval system comprising:
one or more processors;
a communication interface for communicating with a plurality of user terminals;
a memory for loading a computer program performed by the processor; and
a storage for storing the computer program,
wherein the computer program includes instructions for performing operations comprising,
receiving a search request from the user terminal,
extracting a search keyword included in the received search request,
searching databases of a plurality of contact applications to obtain a search result corresponding to the search keyword, and
providing the search result to the user terminal, and
wherein each of the plurality of contact applications has an identifiable name, is associated with a different topic, and can operate independently from each other.

20. A method performed by a user terminal comprising:
transmitting a search request to a retrieval system;
receiving from the retrieval system a search result searched from databases of a plurality of contact applications by the retrieval system in response to the search request; and
displaying the received search result on a screen,
wherein each of the plurality of contact applications has an identifiable name, is associated with a different topic, and can operate independently from each other.
